(19) United States
(12) Patent Application Publication
(10) Pub. No.: US 2024/0138372 A1
(43) Pub. Date: May 2, 2024

(54) Pet Garment

(71) Applicants: Jamie Lynn KENDALL, Wynnewood, PA (US); John Michael SMALTZ, Phoenixville, PA (US); PUPHAZIT, LLC, Wynnewood, PA (US)

(72) Inventors: Jamie Lynn Kendall, Wynnewood, PA (US); John Michael Smaltz, Phoenixville, PA (US)

(73) Assignee: PUPHAZIT, LLC, Wynnewood, PA (US)

(21) Appl. No.: 18/549,441

(22) PCT Filed: Mar. 10, 2022
(86) PCT No.: PCT/US2022/019717

§ 371 Date: Sep. 7, 2023

Related U.S. Application Data
(60) Provisional application No. 63/291,987, filed on Dec. 21, 2021.
(60) Provisional application No. 63/243,120, filed on Sep. 11, 2021.
(60) Provisional application No. 63/159,053, filed on Mar. 10, 2021.

(51) Int. Cl. A01K 13/00; A01K 27/00

(52) U.S. Cl. CPC A01K 13/006; A01K 27/001

(57) ABSTRACT

A pet garment includes a first portion configured to cover a back of a pet, and a second portion fixedly coupled to the first portion. The second portion includes two leg openings configured to receive front legs of the pet, and the second portion is configured to cover a portion of a neck and chest of the pet. There is a collar fixedly coupled to the first portion and second portion. The collar is configured to extend around a portion of a neck of the pet. A zipper is coupled to the collar and first portion. The zipper extends from the collar and along a portion of a length of the first portion. The collar includes a cover releasably covering a portion of the zipper that extends along the collar.

### CROSS-REFERENCE TO RELATED APPLICATIONS

This application claims the benefit of U.S. Provisional Patent Application No. 63/159,053 filed Mar. 10, 2021 entitled “Pet Garment”, U.S. Provisional Patent Application No. 63/243,120 filed Sep. 11, 2021 entitled “Pet Garment”, and U.S. Provisional Patent Application No. 63/291,987 filed Dec. 21, 2021 entitled “Pet Garment”, each of which is incorporated by reference herein in its entirety.

### FIELD OF THE INVENTION

The present invention generally relates to a pet garment for an animal and, more particularly, to a pet garment for providing environmental protection for a pet.

### BRIEF SUMMARY

In one embodiment there is a pet garment including a first portion configured to cover a back of a pet, and a second portion fixedly coupled to the first portion, the second portion including two leg openings configured to receive front legs of the pet, the second portion configured to cover a portion of a neck and chest of the pet. The pet garment further includes a collar fixedly coupled to the first portion and second portion, the collar configured to extend around a portion of a neck of the pet, and a zipper coupled to the collar and first portion, the zipper extending from the collar and along a portion of a length of the first portion. The collar includes a cover releasably covering a portion of the zipper which extends along the collar.

In some embodiments, the two leg openings include an upper edge and a lower edge, the lower edge having a radius of curvature that is less than a radius of curvature of the upper edge. In some embodiments, the upper edge of each of the leg openings is comprised of a non-elastic material and the lower edge of each of the leg openings is comprised of an elastic material. In some embodiments, the first portion and second portion are comprised of different materials. In some embodiments, each of the two legs openings are semi-circular in shape. In some embodiments, the two leg openings are configured to allow the front legs of a pet to pass through while not exposing additional areas of the pet proximate the pet's front legs.

In some embodiments, the two leg openings are disposed at an angle relative to a top surface of the first portion, the angle being between about 5 degrees and about 15 degrees. In some embodiments, each of the two leg openings include an upper edge and a lower edge, the lower edge having a greater elasticity than the upper edge. In some embodiments, the second portion is coupled to the first portion along respective hemlines on a left and right side of the first portion and wherein an upper edge of each of the two leg openings is generally aligned with the respective hemline and each of the two leg openings is generally aligned with one another. In some embodiments, the two leg openings each include a reinforced hemming.

In some embodiments, the second portion is comprised of an elastomeric material. In some embodiments, the second portion is comprised of about 85% nylon and about 15% elastane. In some embodiments, the second portion is comprised of a material having a weight of about 250 grams per square meter. In some embodiments, the first portion is comprised of a fleece fabric. In some embodiments, the first portion is comprised of a fleece fabric having about 400 grams per square meter weight. In some embodiments, the second portion has an elasticity that is greater than an elasticity of the first portion.

In other embodiments, there is a pet garment including a first portion configured to cover a back of a pet and comprised of a fleece fabric, and a second portion fixedly coupled to the first portion and comprised of an elastomeric material, the second portion including two leg openings configured to receive front legs of a pet while not exposing additional areas of the pet, the second portion configured to cover a portion of a neck and chest of the pet. The pet garment further includes a collar fixedly coupled to the first portion and a second portion, the collar configured to cover a portion of a neck of the pet, and a zipper coupled to the collar and the first portion, the zipper extending from the collar and along a portion of a length of the first portion. The collar includes a cover releasably covering a portion of the zipper which extends along the collar, and each of the two leg openings are semi-circular in shape.

In some embodiments, each of the two leg openings include an upper edge having a first radius of curvature and a lower edge having a second radius of curvature, the first radius of curvature being greater than the second radius of curvature. In some embodiments, the upper edge of each of the leg openings is comprised of a non-elastic material and the lower edge of each of the leg openings is comprised of an elastic material. In some embodiments, the two leg openings are disposed at an angle relative to a top surface of the first portion, the angle being between about 5 degrees and about 15 degrees. In some embodiments, the second portion is comprised of a material having a weight of about 250 grams per square meter. In some embodiments, the fleece fabric of the first portion has a weight of about 400 grams per square meter.

In other embodiments, there is a pet garment including a first portion configured to cover a back of a pet, and a second portion fixedly coupled to the first portion, the second portion including two leg openings configured to receive front legs of the pet, the second portion configured to cover a portion of a neck and chest of the pet. The pet harness further includes a collar fixedly coupled to the first portion and second portion, the collar configured to extend around a portion of a neck of the pet, a zipper coupled to the collar and first portion, the zipper extending from the collar and along a portion of a length of the first portion, and a harness fixedly coupled to the first portion and second portion, the harness including at least one attachment element configured to receive a leash. The collar includes a cover releasably covering a portion of the zipper which extends along the collar.

In some embodiments, the harness is positioned between an exterior surface and interior surface of both the first portion and second portion. In some embodiments, the harness is coupled to an exterior surface of both the first portion and second portion and is exterior to the exterior surface. In some embodiments, the at least one attachment element includes a first attachment element and a second attachment element, the first attachment element fixedly coupled to the harness by a first back strap and the second attachment element fixedly coupled to the harness by a second back strap. In some embodiments, a portion of the harness extends around each of the two leg openings and is configured to receive the front legs of the pet. In some embodiments, the first portion and second portion are comprised of different materials.

### BRIEF DESCRIPTION OF THE DRAWINGS

The following detailed description of embodiments of the pet garment, will be better understood when read in conjunction with the appended drawings of exemplary embodiments. It should be understood, however, that the invention is not limited to the precise arrangements and instrumentalities shown.

In the drawings:

FIG. 1 is a side view of a pet garment in accordance with an exemplary embodiment of the present invention shown in use on a dog;

FIG. 2 is a rear view of the pet garment of FIG. 1 shown in use;

FIG. 3 is a bottom view of the pet garment of FIG. 1;

FIG. 4 is a side view of the pet garment of FIG. 1;

FIG. 5 is a front view of the pet garment of FIG. 1 shown in use;

FIG. 6 is a side view of a pet garment in accordance with another exemplary embodiment of the present invention;

FIG. 7, is a top perspective view of the pet garment of FIG. 6 shown in a flat configuration;

FIG. 8 is a top elevational view of the pet garment of FIG. 6 shown in a flat configuration;

FIG. 9 is a bottom elevational view of the pet garment of FIG. 6 shown in a flat configuration;

FIG. 10 is a left-side elevational view of the pet garment of FIG. 6 shown in a flat configuration;

FIG. 11 is a right-side elevational view of the pet garment of FIG. 6 shown in a flat configuration;

FIG. 12 is a perspective view of a pet garment in accordance with another exemplary embodiment of the present invention;

FIG. 13 is a top elevational view of the pet garment of FIG. 12;

FIG. 14 is a bottom elevational view of the pet garment of FIG. 12;

FIG. 15 is a right-side elevational view of the pet garment of FIG. 12; and

FIG. 16 is a left-side elevational view of the pet garment of FIG. 12.

### DETAILED DESCRIPTION

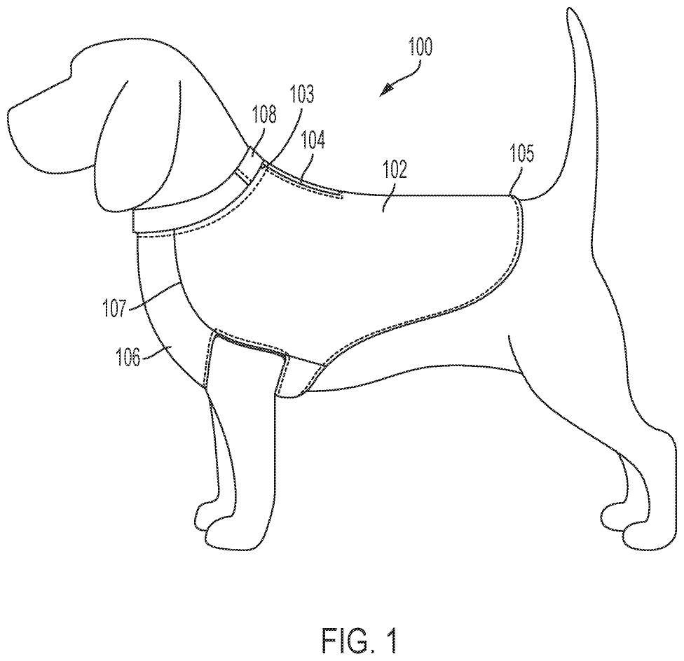

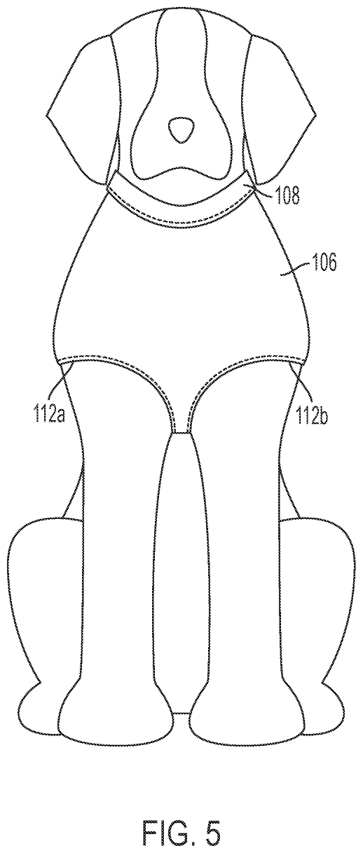

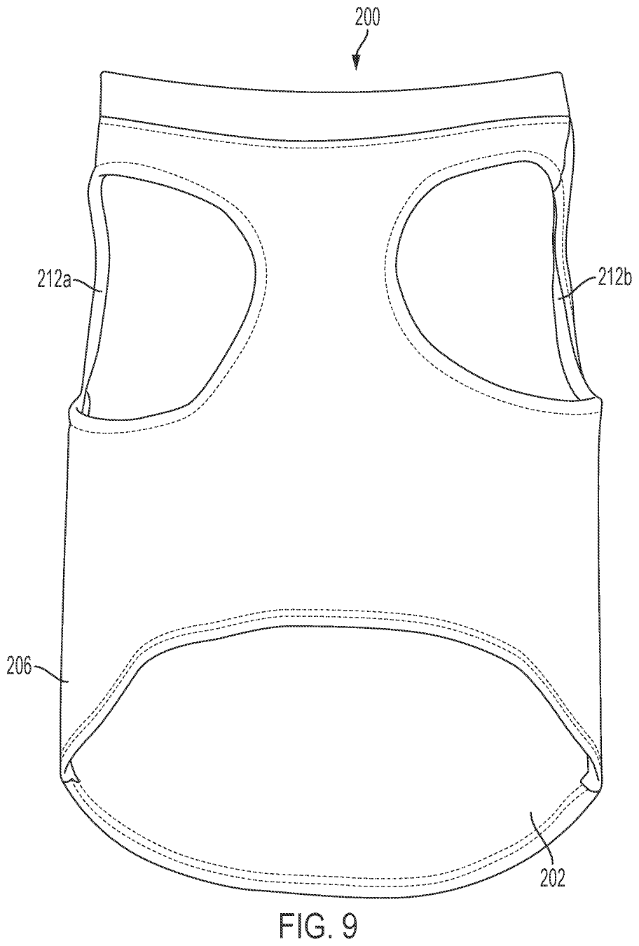

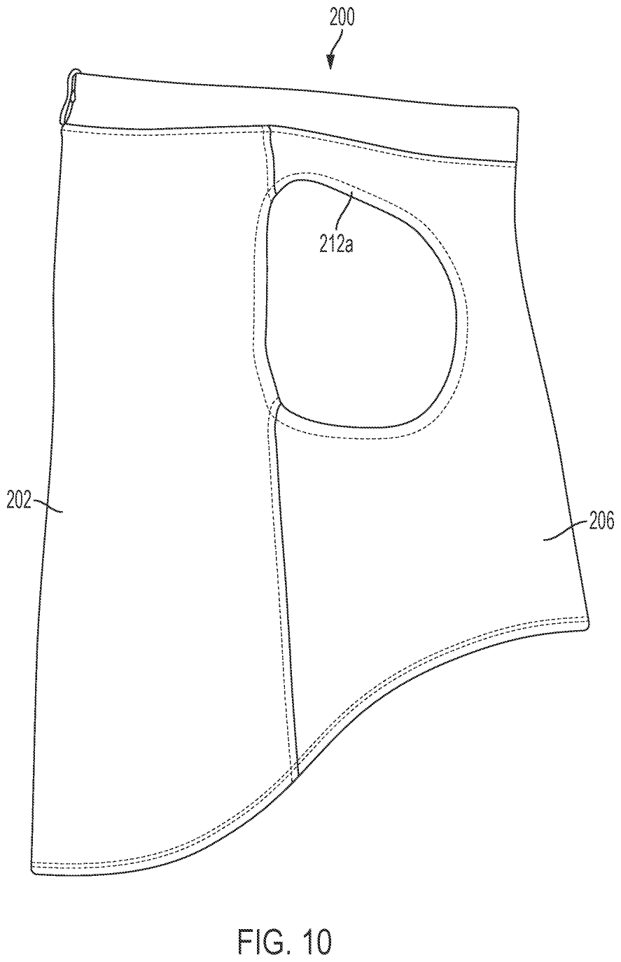

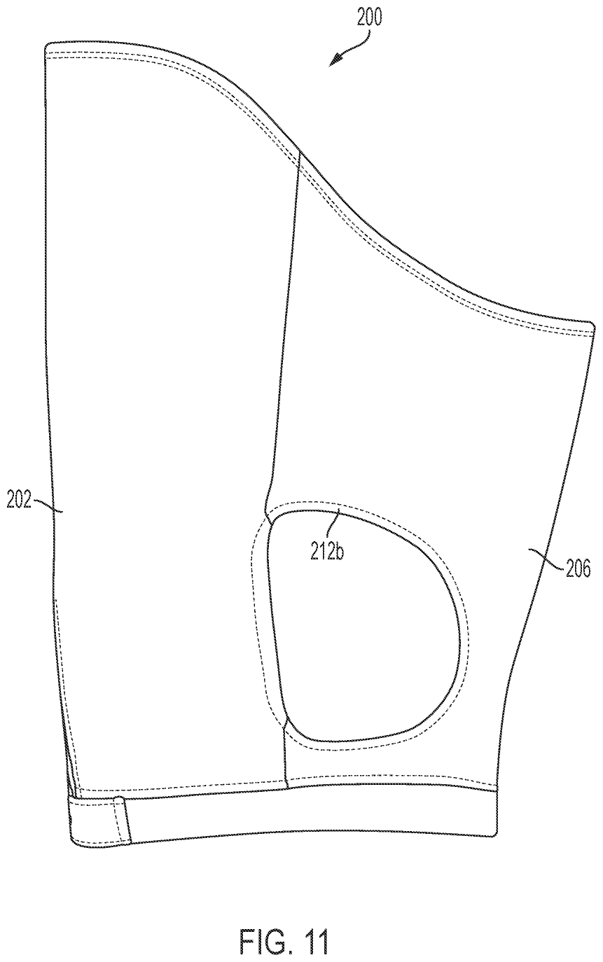

Referring to the drawings in detail, wherein like reference numerals indicate like elements throughout, there is shown in FIGS. 1-16 embodiments of a pet garment in accordance with exemplary embodiments of the present invention. The pet garments may be a vest or jacket to keep the pet warm and/or dry and/or for fashion purposes. The pet garments may include surfaces comprised of different materials such that the pet garment is able to expand and contract with the pet's movements while providing improved protection from weather conditions (e.g., rain, snow, low temperatures). The pet garments may include leg openings configured to form fit to the angle of the pet's shoulder while the pet is walking or running. The pet garments may include an integrated harness system configured to allow a user to attach a leash and/or lead to the pet garment.

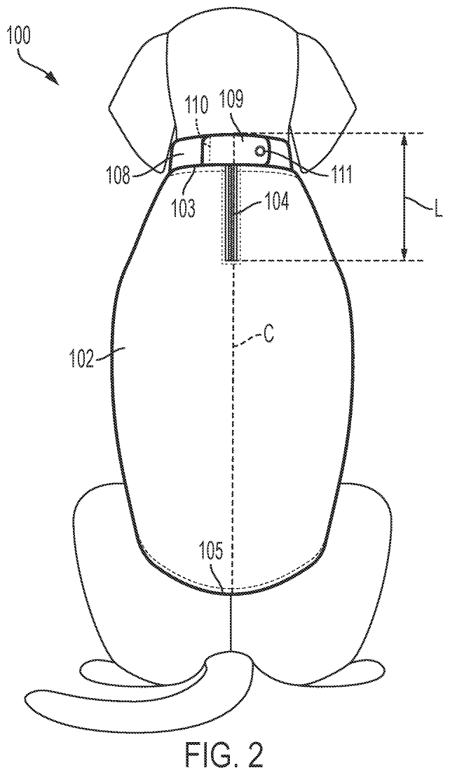

Referring to FIGS. 1-2, the pet garment 100 may include a first portion 102, a zipper 104 coupled to the first portion 102, a second portion 106 disposed below the first portion 102, and a collar 108 coupled to both the first portion 102 and second portion 106. The first portion 102 may be configured to cover at least a portion of a pet and/or animal's back, sides, and/or nape. For example, the first portion 102 may at least partially cover the sides and back of a pet wearing the pet garment 100. In some embodiments, the first portion 102 includes a proximal end 103 configured to be positioned proximate the nape of a pet (e.g., a dog) when worn and a distal end 105 configured to be positioned proximate a rear end and/or tail of the pet when worn. The first portion 102 may extend from the proximal end 103 along a portion of the dog's back to the distal end 105. In some embodiments, the first portion 102 is configured to terminate proximate a pet's rear end and/or tail such that the rear end and/or tail is not covered by the first portion 102. In FIGS. 1-2 the pet garment 100 is shown being worn by a dog, however it will be understood that the pet garment 100 may be worn by a different type of pet or animal such as, but not limited to, a cat, pig, lizard, or any other type of pet. In some embodiments, the size and/or shape of the pet garment 100 may be altered based on the size and shape of the pet intended to wear the pet garment. For example, the size of the pet garment 100 may be increased for larger pets and decreased for smaller pets.

The first portion 102 may be sized to extend from a back of a pet and wrap around to where the pet's front legs meet its chest. For example, the first portion may include a hemline 107 configured to be positioned proximate a pet's shoulder when the pet garment 100 is worn by the pet. The hemline 107 may extend from the proximal end 103, along the sides of the pet toward the distal end 105. The first portion 102 may have a length as measured from where a neck of a pet begins, along a portion of the pet's spinal column to a rear end of the pet. The first portion 102 may be configured to provide environmental protection to a pet placed in the pet garment 100. In some embodiments, the first portion 102 is comprised of a water and/or rain resistant material. In other embodiments, the first portion 102 may be another material that is coated in a water and/or rain resistant material. The first portion 102 may be comprised of a fleece material to provide protection from cold weather and/or rain when a pet is outdoors or exposed to corresponding environmental conditions.

In some embodiments, the first portion 102 is comprised of a fleece fabric having about 400 grams per square meter weight. In some embodiments, the first portion 102 is comprised of a Tier 1, 400 grams per square meter (gsm) heavy luxe fleece fabric. The fleece fabric may be comprised of 100% polyester, anti-piling material and have a soft texture while remaining durable for different weather conditions and/or use conditions. In some embodiments, the first portion 102 may be comprised of a different material that is more suitable to a different environmental condition. For example, the top portion 102 may be comprised of a material configured to dissipate heat.

The collar 108 may be coupled to the first portion 102 proximate where the first portion 102 meets a neck of the pet. For example, the collar 108 is coupled to the proximal end 103 of first portion 102. The collar 108 may be fixedly coupled to first portion 102. For example, the collar 108 may be stitched to first portion 102. In some embodiments, the collar 108 is double stitched to the second portion 106 and first portion 102. Collar 108 may be comprised of an elastomeric material. In some embodiments, collar 108 may be comprised of about 85% nylon, and about 15% elastane. In some embodiments, the collar 108 has a gsm of about 250. Collar 108 may be configured to wrap around the neck of a pet wearing the pet garment 100. Collar 108 may include a cover 109 coupled to a portion of collar 108 near a back area of a pet's neck. Cover 109 may have a first end 110 which is fixedly coupled to collar 108 and a second end 111 which is releasably coupled to collar 108. First end 110 of cover 109 may be stitched to collar 108. Second end 111 may include a snap-fit fastener for releasably coupling to collar 108. In some embodiments, collar 108 and cover 109 are comprised of the same material. In other embodiments, collar 108 and cover 109 are comprised of different materials.

The zipper 104 may be configured to assist in placing a pet in pet garment 100. The zipper 104 may be coupled to the first portion 102 and collar 108 and extending along central axis C. In some embodiments, the zipper 104 extends along a portion of the length of first portion 102 as measured along the central axis C. For example, the zipper may extend along central axis C, from the collar 108 by a length L. The length L of zipper 108 may be between about 6 inches and about 10 inches. For example, the length L may be about 6 inches, about 6.5 inches, about 7 inches, about 7.75 inches, or about 9.75 inches. In other embodiments, the zipper 104 extends along the entire length of first portion 102. The zipper 104 may extend from the first portion 102 across collar 108. The zipper 104 may extend along a width of collar 108. The zipper 104 may be configured to be in one or more open position (not shown) and a closed position (FIG. 2). For example, the zipper 104 may include a slider (not shown) configured to selectively lock the zipper 104 in a closed position and a plurality of open positions. In some embodiments, the zipper 104 is a multi-position locking zipper configured to be locked in one or more positions between the open position and the closed position by the slider.

The zipper 104, when in an open position, may allow the ends of collar 108 and a portion of first portion 102 to open such that a pet's head can more easily pass through than if the zipper 104 was in the closed position. The zipper 104, when in the closed position, may help to prevent heat from escaping the garment and/or unintended removal of the pet garment 100 from the pet. In some embodiments, the zipper 104 may be locked in an open position to allow the pet garment 100 to be worn by pets having various head sizes. The zipper 104 may be configured to provide access to a leash or harness worn under the pet garment 100. In some embodiments, the zipper 104 may be locked in an open position to allow for a connection of a leash to a harness worn by a pet, under the pet garment 100.

In some embodiments, the cover 109 is configured to cover the portion of the zipper 104 which extends along the length of collar 108. In some embodiments, the cover 109 extends over and at least partially conceals a slider that is coupled to zipper 104. The slider may be configured to provide a gripping surface for a user to manually open or close zipper 104. In one embodiment, the zipper 104 is a #3 nylon coil zipper. In other embodiments, the zipper 104 is a #5 nylon coil zipper. The left side of the pet garment is shown in FIG. 1, however, the right side may be symmetrical in appearance to the left side with regards to the first portion 102, zipper 104, and second portion 106. In some embodiments, the zipper 104 may include one or more buffer flaps (not shown) disposed on an interior side of the zipper 104 to prevent the skin and/or fur of a pet wearing the pet garment 100 from being closed within or pulled into the zipper 104 during operation of zipper 104. In some embodiments the buffer flap is comprised of a fleece material.

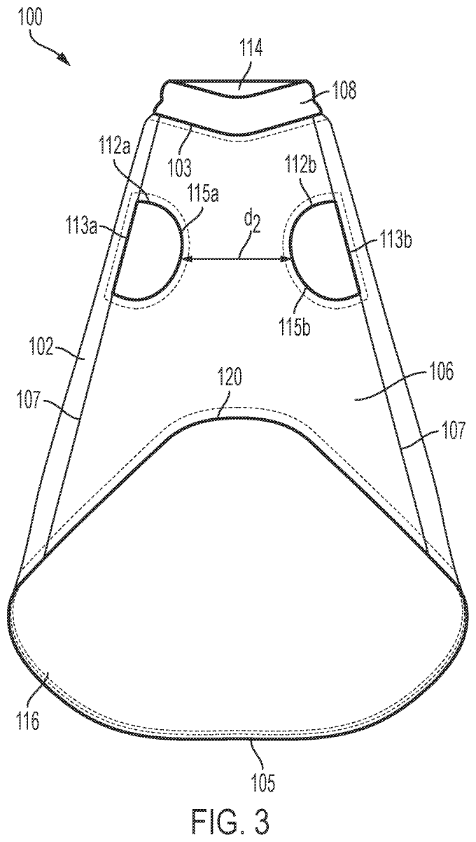

Referring to FIGS. 3-5, the second portion 106 of pet garment 100 may be fixedly coupled to the first portion 102. In some embodiments, the second portion 106 and first portion 102 are stitched together along hemline 107. In some embodiments, the first portion 102 and second portion 106 are double stitched to one another along hemline 107, thereby increasing the durability of the pet garment 100. The second portion 106 may be configured to cover a portion of a pet's neck and/or chest. The second portion 106 may be comprised of a material different than the material that the first portion 102 is comprised of. In some embodiments, the second portion 106 is comprised of an elastomeric material. In some embodiments, the second portion 106 is comprised of a generally stretchable material. In some embodiments, second portion 106 is comprised of a material having a higher elasticity than the material used in the first portion 102. In some embodiments, the second portion 106 may be comprised of about 85% nylon, and about 15% elastane. In some embodiments, the second portion 106 is comprised of a material having a gsm of about 250. In some embodiments, the second portion 106 may include an outer surface 118 and an inner surface (not shown). The inner surface may contact a pet's body when the pet is wearing pet garment 100. The outer surface 118 may face away from a pet when the pet is wearing pet garment 100. In some embodiments, the outer surface 118 is a water repellent outer surface. In some embodiments, the inner surface includes a fleece and/or felt fabric.

The second portion 106 may include leg openings 112a and 112b configured to receive the front legs of a pet wearing pet garment 100. In some embodiments, the leg openings 112a, 112b have a semi-circular shape. In other embodiments, the leg openings 112a, 112b have a semi-circular shape with a generally D-shape perimeter (e.g., a semi-circle with flattened sides). For example, the leg openings 112a and 112b each include a corresponding upper edge 113a and 113b and a lower edge 115a, 115b. The upper edge 113a and 113b may be generally flat or linear and the lower edge 115a and 115b may be curved or rounded such that the front legs of the pet may pass through the leg openings 112a, 112b. In other embodiments, the leg openings 112a, 112b are another shape such as an oval, rectangle, circle, square, or a trapezoidal shape. Leg openings 112a and 112b may be configured to allow the front legs of a pet to pass through while not exposing additional areas of the pet. For example, the upper edges 113a and 113b may be comprised of the same material as the first portion 102 and the lower edges 115a and 115b may be comprised of the same material as the second portion 106. The second portion 106 is more elastic than the first portion 102 thereby allowing the legs of the pet to pass through the openings 112a and 112b while note exposing additional areas of the pet. In other words, the lower edges 115a and 115b may stretch to conform to the shape of the pet's legs. In some embodiments, the size and/or location of the leg openings may be altered to accommodate pets of a different size. For example, the leg openings 112a, 112b may be moved closer to or further away from the collar 108 depending on the relative location of the pet's legs and the size of the openings may be increased or decreased based on the size of the pet's shoulders.

In some embodiments, the leg openings 112a, 112b are configured to prevent bunching and/or gaping at the point of articulation for a pet's legs while the pet is walking or running. For example, the upper edges 113a and 113b being comprised of the same material as the first portion 102 may prevent the upper edges 113a and 113b from stretching while the pet is walking or running. Additionally, the lower edges 115a and 115b being comprised of the same material as the second portion 106 may allow the lower edges 115a and 115b to stretch while the pet is walking or running. The combination of the upper edges 113a and 113b not stretching and the lower edges 115a and 115b stretching, during walking or running, may prevent bunching and/or gaping at the point of articulation for the pet's legs while the pet is walking or running.

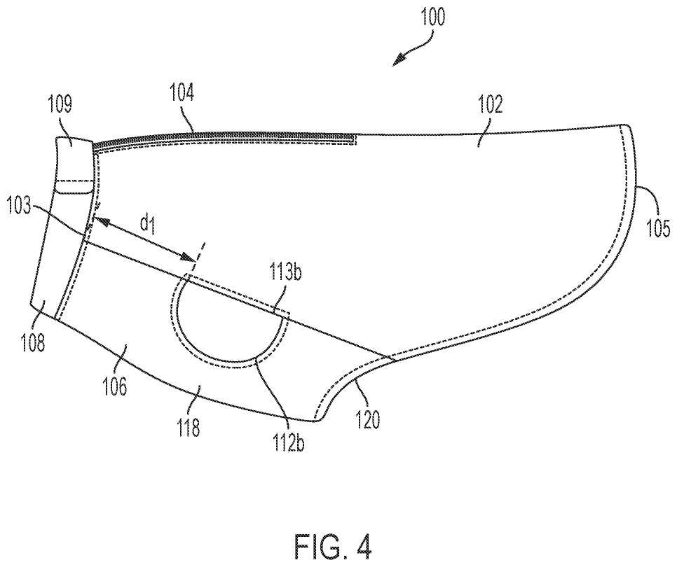

In some embodiments, leg openings 112a, 112b are configured to form fit to an angle of a pet's shoulder angle while the pet is walking or running. For example, the upper edge 113a and 113b may be at an angle θ relative to a top surface of the pet garment 100. A top surface of the pet garment 100 may refer to a surface where central axis C shown in FIG. 2 lies and that is generally parallel to the axis A shown in FIG. 4. By providing the upper edge 113a and 113b at angle θ, the leg openings 112a and 112b may form fit to the angle of the pet's shoulder while the pet is walking or running. In some embodiments the angle θ may be about 10 degrees. In other embodiments, the angle θ may be between about 5 degrees to about 10 degrees. The angle θ may correspond to the physical characteristics of one of the seven major dog groups: working, herding, toy, hound, sporting, non-sporting, terrier. For example, the pet garment 100 may be sized for one of the above dog groups, such as the terrier. As such, the angle θ would correspond to the angle of the terrier's shoulder. In some embodiments, the angle θ may have a direct correlation to the size of the dog. For example, a pet garment 100 sized for a larger breed of dog may include an angle θ (e.g., 8-10 degrees) of the leg openings 112a, 112b that is greater than the angle θ (e.g., 5-7 degrees) of the leg openings 112a, 112b for a pet garment 100 sized for a smaller dog.

In some embodiments, the upper edge 113a and 113b may be generally curved and have a radius of curvature that is greater than the radius of curvature of the lower edge 115a and 115b. In some embodiments, the upper edge 113a and 113b are each positioned along the corresponding hemline 107 a distance d₁ from the proximal end 103 of the first portion 102. The distance d₁ may correspond to the distance from the nape of the pet to the should of the pet such that the leg openings 112a and 112b are aligned with the pet's shoulder when the pet garment 100 is worn. As such, it will be understood that the distance d₁ between the proximal end 103 and upper edge 113a, 113b of the leg openings 112a and 112b may be altered (e.g., reduced or increased) such that the leg openings 112a and 112b align with the shoulder of various pets of different size. Leg openings 112a, 112b may be disposed opposite one another on second portion 106. Leg openings 112a, 112b may be spaced apart from one another by a distance d₂ corresponding to the distance between the front legs of a dog. Leg openings 112a and 112b may be disposed opposite one another on second portion 106. Leg openings 112a and 112b may be spaced apart from one another by a distance d₂ corresponding to the distance between the front legs of a dog.

The upper edges 113a and 113b of leg openings 112a, 112b may be disposed proximate first portion 102. The lower edges 115a and 115b of leg openings 112a, 112b may extend away from first portion 102 along an area of second portion 106. Leg openings 112a, 112b may be positioned between the openings in the pet garment 100 that are configured to receive a pet's neck and rear (e.g., first opening 114 and second opening 116 discussed below). In some embodiments, leg openings 112a, 112b are reinforced leg openings. In some embodiments, the leg openings 112a, 112b include stitching (e.g., double stitching) around the perimeter of the leg openings 112a, 112b for added durability. In some embodiments, the leg openings 112a, 112b include a reinforced hemming to allow for a comfortable and functional fit for a pet wearing pet garment 100. The second portion 106 may include a tapered section 120 to allow for a pet wearing pet garment 100 to urinate without requiring that the pet garment 100 be removed. In some embodiments, the tapered section 120 is a double stitched tapered section.

In some embodiments, the collar 108 may define a first opening 114 disposed at a proximal end of pet garment 100. The first opening 114 may be configured to receive the head and/or neck of a pet wearing the pet garment 100. In some embodiments, the first portion 102 and second portion 106 may define a second opening 116 at a distal end of pet garment 100. The second opening 116 may be configured to allow a rear end of the pet, including a tail, a portion of the pet's back and/or the pet's rear legs to extend distally from opening 116. The pet garment 100 may have a generally frustoconical shape. For example, as shown in FIG. 3, the pet garment 100 has a generally frustoconical shape flaring outwardly from the neck opening (e.g., first opening 114) to the rear opening (e.g., second opening 116).

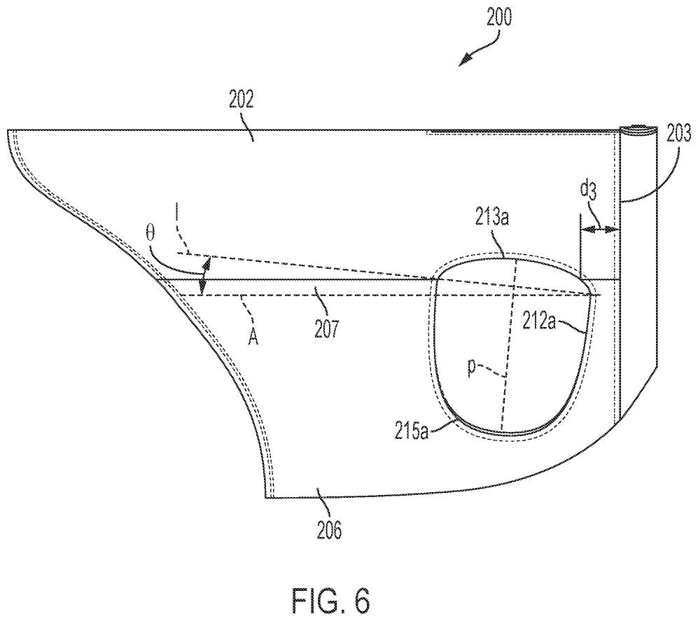

Referring to FIGS. 6-11 there is shown a pet garment, generally designated 200, in accordance with another embodiment of the present disclosure. The pet garment 200 may be generally the same as the pet garment 100 shown in FIGS. 1-5 except that that the leg opening 212b, as well as the leg opening on the opposite side of the pet garment 200, may be positioned closer to the proximal end 203 of the first portion 202. For example, leg opening 212a may be a distance d₃ from the proximal end 203 of the first portion. The distance d₃ may be less than the distance d₁ corresponding to the distance of leg openings 112a, 112b from the proximal end 103 of the first portion 102. Additionally, the leg opening 212a may include an upper edge 213a that extends above the hemline 207 toward the first portion, and a lower edge 215a that extends below the hemline 207 toward the second portion 206. The upper edge 213a may be generally curved and the lower edge 215a may also be generally curved. The upper edge 213a may have a radius of curvature that is greater than the radius of curvature of the lower edge 215a. It will be understood that the leg opening on the opposite side (not shown) may have an identical structure and/or features.

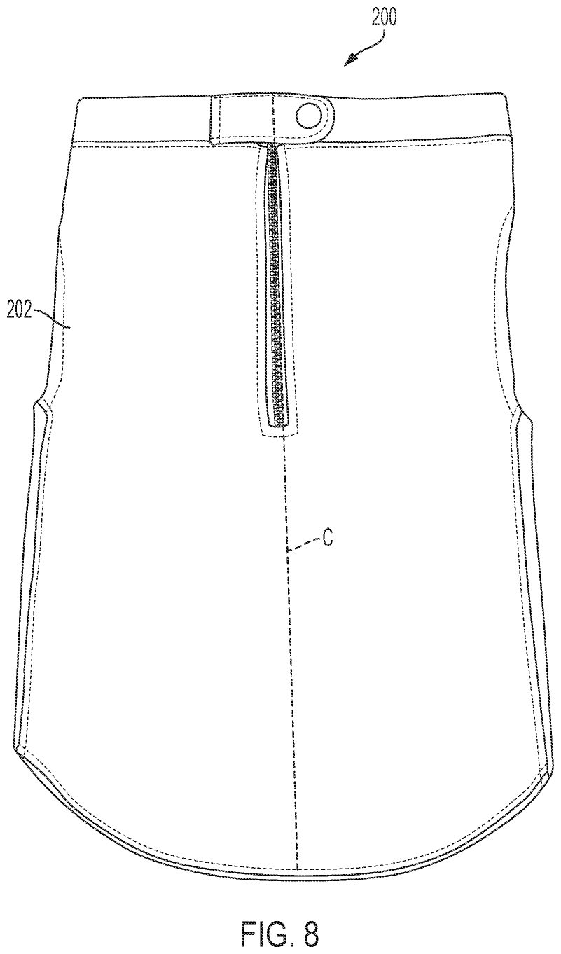

In some embodiments, both leg opening 212a and 212b are configured to form fit to an angle of a pet's shoulder angle while the pet is walking or running. For example, an axis I may be drawn between the two points where the upper edge 213a lower edge 215b meet, as shown in FIG. 6. The leg opening 212a may be oriented relative to the collar 208 and/or the top surface of the pet garment 200 based on the axis I. For example, there may be an axis P, perpendicular to axis I and centered between the two points where the upper edge 213a and lower edge 215b meet. The perpendicular axis P may intersect the peak of the upper edge 213a and the valley of the lower edge 215a. As such, the leg openings 212a and 212b may be disposed at an angle relative to the top surface of the pet garment 200 and/or relative to the collar 208. In this example, the top surface of the pet garment 200 is referenced. The axis I may be at an angle θ relative to a top surface of the pet garment 200. A top surface of the pet garment 200 may refer to a surface where central axis C shown in FIG. 8 lies and that is generally parallel to the axis A shown in FIG. 6. Although only leg opening 212a is shown in FIG. 6, it will be understood that leg opening 212b, on the opposite side of the pet garment 200 has substantially the same configuration.

By providing the upper edge 213a at angle θ, the leg opening 212a may form fit to the angle of the pet's shoulder while the pet is walking or running. In some embodiments the angle θ may be about 10 degrees. In other embodiments, the angle θ may be between about 5 degrees to about 10 degrees. The angle θ may correspond to the physical characteristics of one of the seven major dog groups: working, herding, toy, hound, sporting, non-sporting, terrier. For example, the pet garment 200 (or pet garment 100) may be sized for one of the above dog groups, such as the terrier. As such, the angle θ would correspond to the angle of the terrier's shoulder. In some embodiments, the angle θ may have a direct correlation to the size of the dog. For example, a pet garment 200 sized for a larger breed of dog may include an angle θ (e.g., 8-10 degrees) of the leg openings 212a, 212b that is greater than the angle θ (e.g., 5-7 degrees) of the leg openings 212a, 212b for a pet garment 200 sized for a smaller dog.

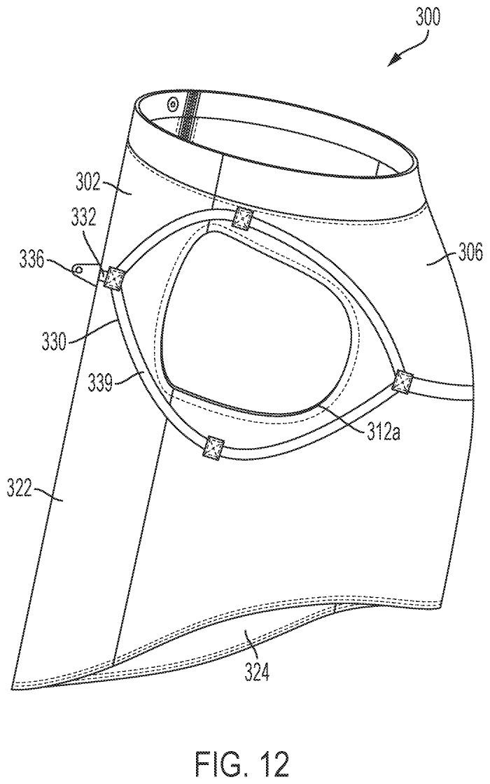

Referring to FIGS. 12-16, there is shown a pet garment, generally designated 300, in accordance with another exemplary embodiment of the present invention. The pet garment 300 may be generally the same as pet garment 200 shown in FIGS. 6-11 except that there may be harness 330 coupled to the pet garment 300. The harness 330 may be configured to allow a user to attach a leash or lead to the harness 330 to control the movement of a pet wearing the pet garment 300. The harness 330 may include a series of straps, or webbing, that loop around the pet's legs, chest, and/or back such that, a user may restrain or control movement of the pet wearing the pet garment 300. In some embodiments, one or more of the straps that are included in the harness 330 are coupled to an exterior surface 322 of the pet garment 300. For example, the straps included in the harness 330 may extend along the exterior surface 322 from the first portion 302 of the pet garment 300, to the second portion 306, and around and between the leg openings 312a, 312b. In this manner, the straps included in the harness 330 may be exposed, or visible, at the exterior surface 322 of the pet garment 300.

In other embodiments, the straps that are included in the harness 330 are coupled to the pet garment 300 such that they are interior to the exterior surface 322. For example, the pet garment 300 may include an interior surface 324 comprised of one or more layers of fabric and/or material and the exterior surface 322 may be comprised of one or more other layers of fabric and/or material. The straps included in the harness 330 may be positioned between the interior surface 324 and the exterior surface 322 (e.g., positioned between the layers of the interior surface 324 and exterior surface 322). In this manner the straps included in the harness 330 may be at least partially hidden from view. In some embodiments, the straps that are included in the harness 330 are coupled to and protrude from the interior surface 324. Put another way, the straps included in the harness 330 may be positioned between the body of the pet and the interior surface 324 of the pet garment 300 when worn by the pet. In some embodiments, the straps included in the harness 330 are fixedly coupled (e.g., stitched to) one or more of the interior surface 324 and exterior surface 322 of the pet garment 300.

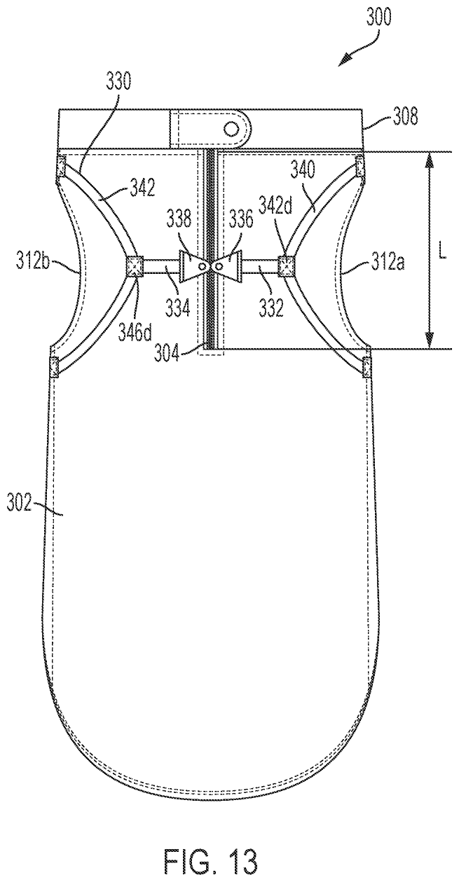

In some embodiments, the harness 330 includes at least one strap configured to couple a leash to the harness 330. The at least one strap configured to couple the leash to the harness 330 may be positioned on the pet garment 300 such that it is proximate a back of the pet when the pet is wearing the pet garment 300. In some embodiments, the harness 330 includes a first back strap 332 and a second back strap 334 each coupled to a respective first attachment element 336 and a second attachment element 338 (shown in FIG. 13). In some embodiments, the first back strap 332 and second back strap 334 are not directly coupled to one another such that a terminal end of each (e.g., where the attachment elements 336, 338 are coupled thereto) may be moved or adjusted by a user. For example, a user may wish to move or adjust the first back strap 332 and/or second back strap 334 such that the user may freely operate zipper 304. As shown in FIG. 13, the zipper 304 extends along first portion 302 of the pet garment 300 by a length L, generally the same as pet garments 100, and 200. The length L of the zipper 304 is great enough such that at least one of the back straps 332, 334 and/or attachment elements 336, 338 may partially obscure the zipper 304. As such, the back straps 332, 334 may not be directly coupled to one another to allow the user to move the back straps 332, 334 and/or attachment elements 336, 338 away from the zipper 304 so that the zipper 304 is not obscured.

In other embodiments, the zipper 304 may be sized such that the first back strap 332, second backstrap 334, first attachment element 336, and/or the second attachment element 338 does not obscure the zipper 304. For example, the zipper 304 may extend along the first portion 302, from the collar 308 a length that is less than length L such that the zipper 304 is not obscured by the first back strap 332, second back strap 334, first attachment element 336, and/or second attachment element 338. In some embodiments, the first back strap 332 and second back strap 334 may be directly coupled to one another. For example, the first back strap 332 and second back strap 334 may be a single continuous strap. In some embodiments, the first back strap 332 and second back strap 334 are at least partially fixedly coupled to the pet garment 300. For example, at least a portion of each of the first back strap 332 and second back strap 334 may be stitched to the pet garment 300.

In embodiments where the harness 330 is positioned between the exterior surface 322 and interior surface 324 of the pet garment, the first back strap 332 and/or second back strap 334 may extend from below the exterior surface 322 to above the exterior surface 322 such that the attachment elements 336, 338 may be accessed by a user. For example, there may be one or more openings (not shown) along the exterior surface 306 of the first portion 302 of the pet garment 300 such that the back straps 332, 334 may extend therethrough. In this manner, the back straps 332, 334 may extend partially above the exterior surface 322 of the pet garment 300 while the remaining portions of the harness 330 remain disposed between the exterior surface 322 and interior surface 324. In embodiments, where the harness 330 is positioned interior to the interior surface 324 of the pet garment, the first back strap 332 and/or second back strap 334 may extend from a position interior to the interior surface 324, to a position exterior to the exterior surface 322 such that the attachment elements 336, 338 may be accessed by a user.

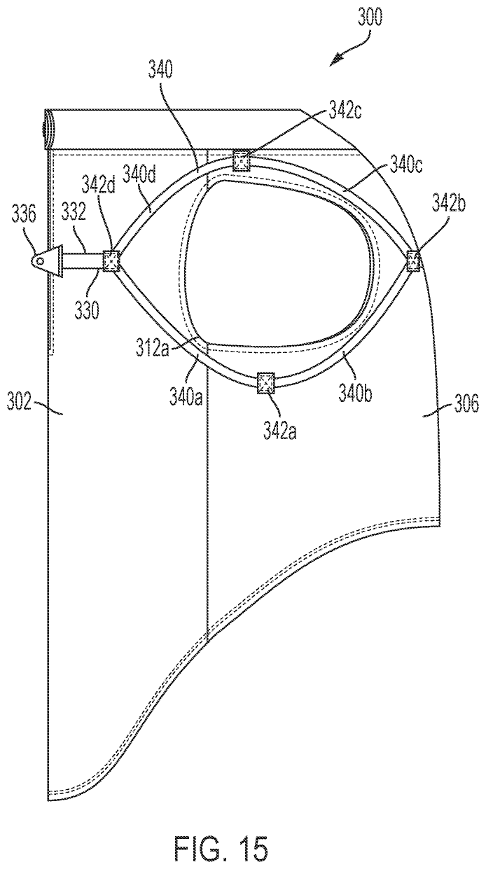

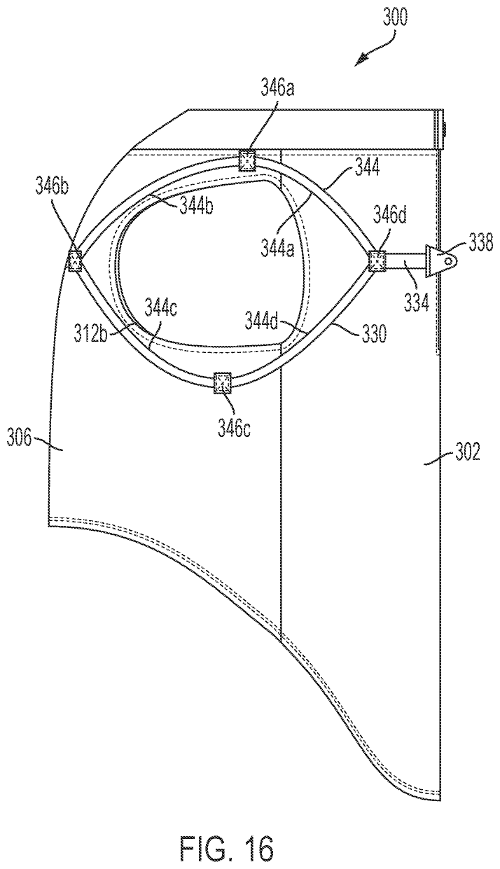

In some embodiments, the harness 330 may include a first set of leg straps 340 and a second set of leg straps 344 each configured to allow the front legs of a pet wearing the pet garment 300 to extend therethrough. The first set of leg straps 340 may be positioned proximate the first leg opening 312a (shown in FIG. 15) of the pet garment 300 and the second set of leg straps 344 may be positioned proximate the second leg opening 312b (shown in FIG. 16). The first set of leg straps 340 may be generally proximate to and extend around the first leg opening 312a. In some embodiments, the first set of leg straps 340 do not extend across the leg opening 312a. For example, the first set of leg straps 340 may be positioned proximate the first leg opening 312a and may extend around a periphery of the leg opening 312a without extending across the periphery of the leg opening 312a.

In some embodiments, the first set of leg straps 340 includes one or more straps coupled one to another. For example, the first set of leg straps 340 may include a first strap 340a, a second strap 340b, a third strap 340c, and a fourth strap 340d. The first strap 340a may be coupled to the second strap 340b at a coupling location 342a, the second strap 340b may be coupled to the third strap 340c at a coupling location 342b, the third strap 340c may be coupled to the fourth strap 340d at a coupling location 342c, and the fourth strap 340d may be coupled to the first strap 340a at a coupling location 342d. The coupling locations 342a-342d may be an area on the pet garment 300 that includes reinforced padding and/or stitching that is configured to secure the position of the first set of leg straps 340 relative to the first leg opening 312a. For example, at each coupling location 342a-342d, there may be stitching that fixedly couples the straps 340a-340d one to another. In this manner, coupling locations 342a-342d may at least partially define the orientation and position of the corresponding straps 340a-340d relative to the leg opening 312a. In some embodiments, the straps 340a-340d are double stitched to each other at the respective coupling locations 342a-342d. In some embodiments, there are more than four coupling locations 342 and straps included in the first set of leg straps 340.

In some embodiments, at least one of the straps 340a-340d is integrally formed with at least one other of the straps 340a-340d. For example, the first strap 340a and second strap 340b may be a single integrally formed strap that is fixedly coupled to the pet garment 300 at coupling locations 342a, 342b, and 342d. Similarly, the third strap 340c and fourth strap 340d may be a single integrally formed strap that is fixedly coupled to the pet garment 300 at coupling locations 342b-342d. In some embodiments, at least one of the straps 340a-340d may include stitching that extends along the respective strap 340a-340d and between the corresponding two coupling locations 342a-342d. For example, the first strap 340a may include stitching that extends along the length of the first strap 340a and between coupling locations 342a and 342d. It will be understood that the first set of leg straps 340 illustrated in FIG. 15 is an example and that there may be more or fewer than four straps may be included there may be more or fewer than four corresponding coupling locations included in the first set of leg straps 340. In some embodiments, the first back strap 332 is coupled to the first set of leg straps 340. For example, the first back strap 332 may be fixedly coupled to the first set of leg straps 340 at the coupling location 342d.

The second set of leg straps 344 (shown in FIG. 16) may be generally the same as the first set of leg straps 340. For example, the second set of leg straps 344 may include a first strap 344a, second strap 344b, third strap 344c, and fourth strap 344d coupled to one another at corresponding coupling locations 346a-346d generally the same as straps 340a-340d and coupling locations 342a-342d. As such, for sake of brevity and so as not to obscure aspects of the present invention, the second set of leg straps 344 will not be described in full detail. It will be understood that the description of the first set of leg straps 340, and the features thereof, applies to the second leg straps 344. It will also be understood that the description of the first set of leg straps 340 in relation to the first leg opening 312a may be generally the same as the description of the second set of leg straps 344 in relation to the second leg opening 312b. It will further be understood that the description of the first set of leg straps 340 in relation to the first back strap 332 is generally the same as the description of the second set of leg straps 344 in relation to the second back strap 334.

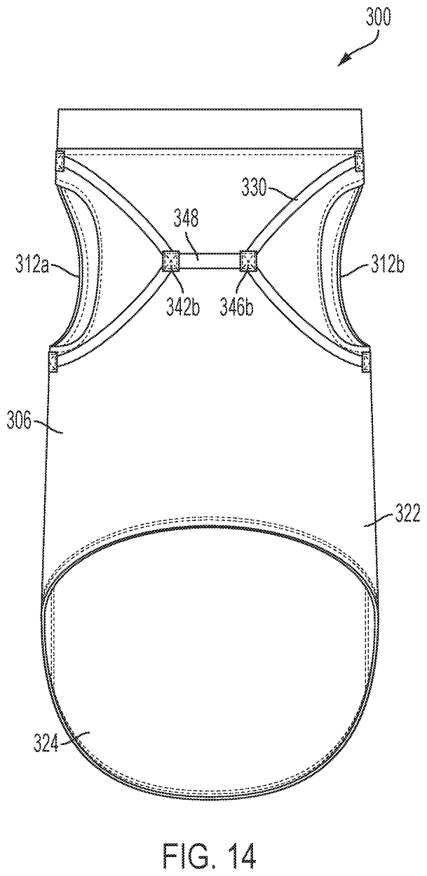

In some embodiments, the harness 330 includes a chest strap 348 (shown in FIG. 14) configured to extend across at least a portion of a pet's chest when the pet is wearing the pet garment 300. The chest strap 348 may be coupled to and extend between the first set of leg straps 340 and the second set of leg straps 344. For example, the chest strap 348 may be fixedly coupled to the first set of leg straps 340 at coupling location 342b. Similarly, the chest strap 348 may be fixedly coupled to the second set of leg straps 344 at coupling location 346b. In this manner, the chest strap 348 may be fixedly coupled to both of the first set of leg straps 340 and second set of leg straps 344. In some embodiments, the chest strap 348 is fixedly coupled to the pet garment 300 along a substantial length of the chest strap 348. For example, there may be stitching or an adhesive extending along the length of the chest strap 348 between coupling point 342b and coupling points 346b that fixedly couples the chest strap 348 to the pet garment 300. In other embodiments, the chest strap 348 is at least partially moveable relative to the pet garment 300. For example, the chest strap 348 may be fixedly coupled to the pet garment 300 at coupling locations 342b and 346b such that the portion of the chest strap 348 that extends between the two locations 342b and 346b may be able to move relative to the pet garment 300.

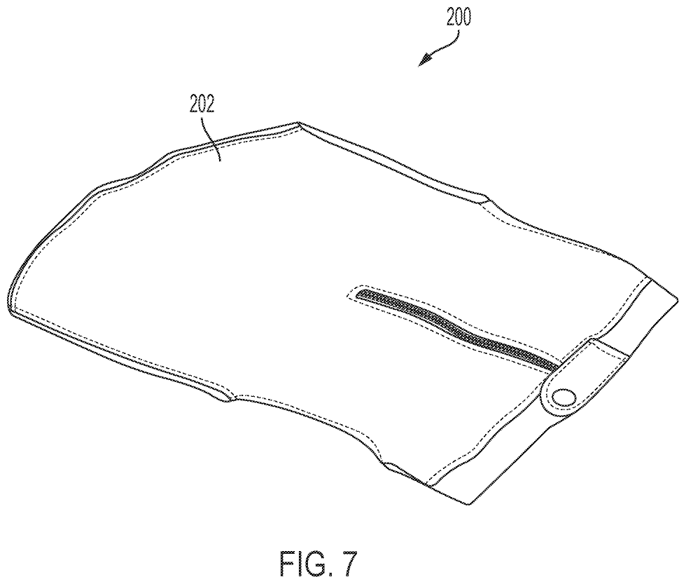

In some embodiments, the straps included in the harness 330 (e.g., the back straps 332, 334, leg opening straps 340, 344, and chest strap 348) are comprised of a generally non-stretchable material. In some embodiments, the straps included in the harness 330 are comprised of a woven material (e.g., a woven nylon). In some embodiments, each of the straps included in the harness 330 are comprised of the same material. In some embodiments, one or more of the pet garments 100, 200, 300 may include reflective material(s) positioned along one or more areas of the respective pet garment 100, 200, 300. The reflective materials may increase the visibility of a pet wearing the pet garment 100, 200, or 300 during use in low visibility environments (e.g., at night, early morning prior to the sun rising). In some embodiments, there is a reflective material positioned along one or more of the seams of the pet garment 100, 200, and/or 300. For example, in FIGS. 7-11, the pet garment 200 is shown in various flat configurations.

The broken lines in FIGS. 7-11 may depict stitching and/or seams of the pet garment 200 with the exception of the broken line representing axis C in FIG. 8. In some embodiments, there may be one or more reflective portions that extends at least partially along the seams and/or are positioned proximate the seams. The reflective portions may be disposed on the outer surface of the pet garment 200 such that they may reflect light generated by an external source (e.g., car headlights). In some embodiments, there may be reflective portions/materials, positioned proximate the leg openings, zipper, collar, and/or tapered section of any one of the pet garments 100, 200, 300. In some embodiments, one or more portions of the harness 330 of pet garment 300 may include a reflective material.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A pet garment comprising:
a first portion configured to cover a back of a pet;
a second portion fixedly coupled to the first portion, the second portion including two leg openings configured to receive front legs of the pet, the second portion configured to cover a portion of a neck and chest of the pet;
a collar fixedly coupled to the first portion and second portion, the collar configured to extend around a portion of a neck of the pet; and
a zipper coupled to the collar and first portion, the zipper extending from the collar and along a portion of a length of the first portion,
wherein the collar includes a cover releasably covering a portion of the zipper which extends along the collar.

2. The pet garment of claim 1, wherein the two leg openings include an upper edge and a lower edge, the lower edge having a radius of curvature that is less than a radius of curvature of the upper edge.

3. The pet garment of claim 2, wherein the upper edge of each of the leg openings is comprised of a non-elastic material and the lower edge of each of the leg openings is comprised of an elastic material.

4. The pet garment of claim 1, wherein the first portion and second portion are comprised of different materials.

5. The pet garment of claim 1, wherein each of the two legs openings are semi-circular in shape.

6. The pet garment of claim 1, wherein the two leg openings are configured to allow the front legs of a pet to pass through while not exposing additional areas of the pet proximate the pet's front legs.

7. The pet garment of claim 1, wherein the two leg openings are disposed at an angle relative to a top surface of the first portion, the angle being between about 5 degrees and about 15 degrees.

8. The pet garment of claim 1, wherein each of the two leg openings include an upper edge and a lower edge, the lower edge having a greater elasticity than the upper edge.

9. The pet garment of claim 1, wherein the second portion is coupled to the first portion along respective hemlines on a left and right side of the first portion and wherein an upper edge of each of the two leg openings is generally aligned with the respective hemline and each of the two leg openings is generally aligned with one another.

10. (canceled)

11. The pet garment of claim 1, wherein the second portion is comprised of an elastomeric material.

12. The pet garment of claim 1, wherein the second portion is comprised of about 85% nylon and about 15% elastane.

13. (canceled)

14. The pet garment of claim 1, wherein the first portion is comprised of a fleece fabric.

15. (canceled)

16. The pet garment of claim 1, wherein the second portion has an elasticity that is greater than an elasticity of the first portion.

17. A pet garment comprising:
a first portion configured to cover a back of a pet and comprised of a fleece fabric;
a second portion fixedly coupled to the first portion and comprised of an elastomeric material, the second portion including two leg openings configured to receive front legs of a pet while not exposing additional areas of the pet, the second portion configured to cover a portion of a neck and chest of the pet;
a collar fixedly coupled to the first portion and a second portion, the collar configured to cover a portion of a neck of the pet; and
a zipper coupled to the collar and the first portion, the zipper extending from the collar and along a portion of a length of the first portion,
wherein the collar includes a cover releasably covering a portion of the zipper which extends along the collar, and
wherein each of the two leg openings are semi-circular in shape.

18. The pet garment of claim 17, wherein each of the two leg openings include an upper edge having a first radius of curvature and a lower edge having a second radius of curvature, the first radius of curvature being greater than the second radius of curvature.

19. The pet garment of claim 18, The pet garment of claim 19, wherein the upper edge of each of the leg openings is comprised of a non-elastic material and the lower edge of each of the leg openings is comprised of an elastic material.

20. The pet garment of claim 17, wherein the two leg openings are disposed at an angle relative to a top surface of the first portion, the angle being between about 5 degrees and about 15 degrees.

21-22. (canceled)

23. A pet garment comprising:
a first portion configured to cover a back of a pet;
a second portion fixedly coupled to the first portion, the second portion including two leg openings configured to receive front legs of the pet, the second portion configured to cover a portion of a neck and chest of the pet;
a collar fixedly coupled to the first portion and second portion, the collar configured to extend around a portion of a neck of the pet;
a zipper coupled to the collar and first portion, the zipper extending from the collar and along a portion of a length of the first portion; and
a harness fixedly coupled to the first portion and second portion, the harness including at least one attachment element configured to receive a leash,
wherein the collar includes a cover releasably covering a portion of the zipper which extends along the collar.

24. The pet garment of claim 23, wherein the harness is positioned between an exterior surface and interior surface of both the first portion and second portion.

25. The pet garment of claim 23, wherein the harness is coupled to an exterior surface of both the first portion and second portion and is exterior to the exterior surface.

26. The pet garment of claim 23, wherein the at least one attachment element includes a first attachment element and a second attachment element, the first attachment element fixedly coupled to the harness by a first back strap and the second attachment element fixedly coupled to the harness by a second back strap.

27. The pet garment of claim 23, wherein a portion of the harness extends around each of the two leg openings and is configured to receive the front legs of the pet.

28. (canceled)
